(19) United States
(12) Patent Application Publication
(10) Pub. No.: US 2021/0327435 A1
(43) Pub. Date: Oct. 21, 2021

(54) VOICE PROCESSING DEVICE, VOICE PROCESSING METHOD, AND PROGRAM RECORDING MEDIUM

(71) Applicant: NEC Corporation, Minato-ku, Tokyo (JP)

(72) Inventors: Hitoshi YAMAMOTO, Tokyo (JP); Takafumi KOSHINAKA, Tokyo (JP)

(73) Assignee: NEC Corporation, Minato-ku, Tokyo (JP)

(21) Appl. No.: 17/273,360

(22) PCT Filed: Sep. 6, 2018
(86) PCT No.: PCT/JP2018/033027

§ 371 Date: Mar. 4, 2021

(51) Int. Cl. G10L 17/02; G10L 17/26; G10L 15/10; G10L 15/00; G10L 25/63

(52) U.S. Cl. CPC G10L 17/02; G10L 17/26; G10L 25/63; G10L 15/005; G10L 15/10

(57) ABSTRACT

A voice processing device, a voice processing method, and a program recording medium that enhance accuracy of speaker recognition are provided.

A voice processing device 100 includes a voice statistics calculation unit 120 that calculates voice statistics that indicates an appearance of each type of sound included in a voice signal that indicates a voice, and a second feature calculation unit 140 that calculates a second feature to recognize specific attribute information based on a temporal change of the voice statistics.

### TECHNICAL FIELD

The present disclosure relates to a voice processing device, a voice processing method, and a program recording medium.

### BACKGROUND ART

A voice processing device that calculates speaker characteristics indicating individuality to specify a speaker who utters a voice from a voice signal has been known. A speaker recognition device that estimates the speaker who utters a voice signal using this speaker characteristics has been known.

This type of speaker recognition device using the voice processing device evaluates a similarity between a first speaker characteristic extracted from a first voice signal and a second speaker characteristic extracted from a second voice signal in order to specify the speaker. Then, the speaker recognition device determines whether speakers of the two voice signals are the same on the basis of the evaluation result regarding the similarity.

NPL 1 describes a technique for extracting speaker characteristics from a voice signal. The speaker characteristics extraction technique described in NPL 1 calculates voice statistics using a voice model. Then, the speaker characteristics extraction technique described in NPL 1 processes the voice statistics on the basis of the factor analysis technique and calculates the amount as a vector expressed by the predetermined number of elements. That is, in NPL 1, a speaker characteristics vector is used as the speaker characteristics that indicate the individuality of the speaker.

### CITATION LIST

### Non Patent Literature

[NPL 1] Najim Dehak, Patrick Kenny, Reda Dehak, Pierre Dumouchel, and Pierre Ouellet, “Front-End Factor Analysis for Speaker Verification,” IEEE Transactions on Audio, Speech and Language Processing, Vol. 19 (2011), No. 4, pp. 788-798.

### SUMMARY OF INVENTION

### Technical Problem

However, the technique described in NPL 1 has had a problem in that accuracy of speaker recognition using the extracted speaker characteristics is not sufficient.

The technique described in NPL 1 executes predetermined statistical processing on a voice signal input to the speaker characteristics extraction device and calculates a speaker characteristics vector. More specifically, the technique described in NPL 1 calculates individuality characteristics of a speaker who pronounces each sound by executing acoustic analysis processing in partial section units on the voice signal input to the speaker characteristics extraction device and calculates the speaker characteristics vector of the entire voice signal by executing statistical processing on the individuality characteristics. Therefore, according to the technique described in NPL 1, it is not possible to capture the individuality of the speaker that appears in a range wider than the partial section of the voice signal. Therefore, there is a possibility that accuracy of the speaker recognition is deteriorated.

The present disclosure has been made in consideration of the above problems, and an example of an object is to provide a voice processing device, a voice processing method, and a program recording medium that enhance accuracy of speaker recognition.

### Solution to Problem

A voice processing device according to one aspect of the present disclosure includes voice statistics calculation means for calculating voice statistics that indicates an appearance of each type of sound included in a voice signal that indicates a voice and

second feature calculation means for calculating a second feature to recognize specific attribute information on the basis of a temporal change of the voice statistics.

A voice processing method according to one aspect of the present disclosure includes calculating voice statistics that indicates an appearance of each type of sound included in a voice signal that indicates a voice and calculating a second feature to recognize specific attribute information on the basis of a temporal change of the voice statistics.

A program recording medium according to one aspect of the present disclosure records a program for causing a computer to execute processing including processing for calculating voice statistics that indicates an appearance of each type of sound included in a voice signal that indicates a voice and processing for calculating a second feature to recognize specific attribute information on the basis of a temporal change of the voice statistics.

### Advantageous Effects of Invention

According to the present disclosure, it is possible to provide a voice processing device, a voice processing method, and a program recording medium that enhance accuracy of speaker recognition.

### BRIEF DESCRIPTION OF DRAWINGS

FIG. 1 shows a block diagram illustrating a hardware configuration of a computer device that achieves a device in each example embodiment.

FIG. 2 shows a block diagram illustrating a functional configuration of a voice processing device according to a first example embodiment.

FIG. 3A shows a diagram for schematically explaining a method for calculating a second feature by a second feature calculation unit of the voice processing device according to the first example embodiment.

FIG. 3B shows a diagram for schematically explaining the method for calculating the second feature by the second feature calculation unit of the voice processing device according to the first example embodiment.

FIG. 3C shows a diagram for schematically explaining the method for calculating the second feature by the second feature calculation unit of the voice processing device according to the first example embodiment.

FIG. 4 shows a flowchart illustrating an example of an operation of the voice processing device according to the first example embodiment.

FIG. 5 shows a block diagram illustrating a configuration of a voice processing device 200 according to a second example embodiment.

FIG. 6 shows a block diagram illustrating a functional configuration of a voice processing device according to an example embodiment having a minimum configuration.

### EXAMPLE EMBODIMENT

Example embodiments are described below with reference to the drawings. Note that, because components denoted with the same reference numerals in the example embodiments perform similar operations, there is a case where overlapped description is omitted. A direction of an arrow in the drawings indicates an example, and does not limit directions of signals between blocks.

### First Example Embodiment

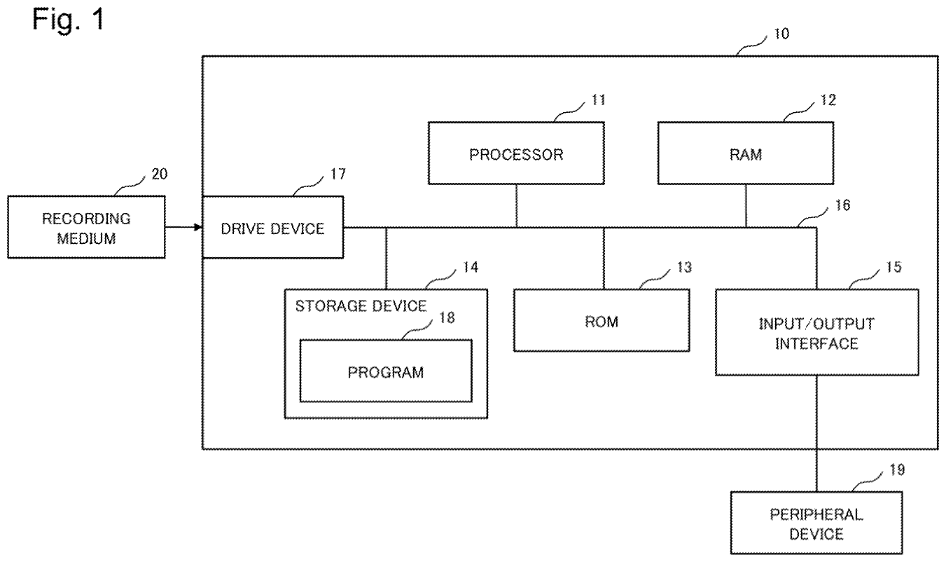

Hardware included in a voice processing device according a first example embodiment and another example embodiment is described. FIG. 1 is a block diagram illustrating a hardware configuration of a computer device 10 that achieves a voice processing device and a voice processing method according to each example embodiment. In each example embodiment, each component of the following voice processing device indicates a block in functional units. Each component of the voice processing device can be achieved, for example, by any combination of the computer device 10 as illustrated in FIG. 1 and software.

As illustrated in FIG. 1, the computer device 10 includes a processor 11, a Random Access Memory (RAM) 12, a Read Only Memory (ROM) 13, a storage device 14, an input/output interface 15, and a bus 16.

The storage device 14 stores a program 18. The processor 11 executes the program 18 related to the voice processing device or the voice processing method using the RAM 12. The program 18 may be stored in the ROM 13. In addition, the program 18 may be recorded in a recording medium 20 and read by a drive device 17 or may be transmitted from an external device via a network.

The input/output interface 15 exchanges data with peripheral devices (keyboard, mouse, display device, or the like) 19. The input/output interface 15 can function as means for acquiring or outputting data. The bus 16 connects the components.

There are various modifications of the method for achieving the voice processing device. For example, each unit of the voice processing device can be achieved as hardware (dedicated circuit). The voice processing device can be achieved by a combination of a plurality of devices.

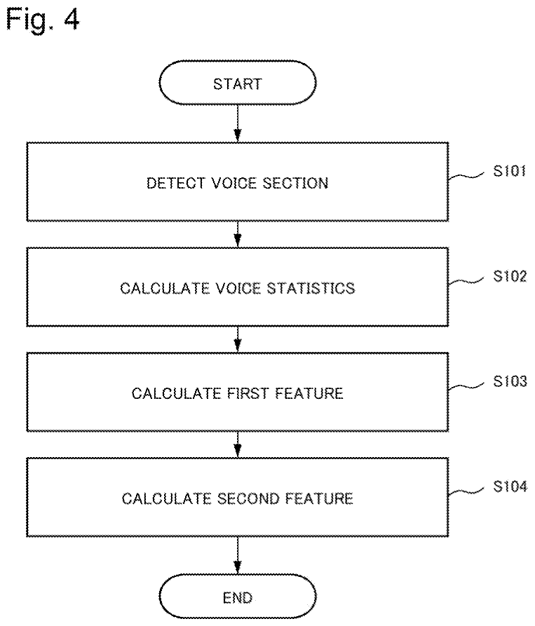

A processing method for causing a recording medium to record a program (more specifically, program that causes computer to execute processing illustrated in FIG. 4 or the like) that operates the component of each example embodiment in such a way as to achieve the functions of the present example embodiment and the other example embodiments, reading the program recorded in the recording medium as a code, and executing the program by the computer is included in the scope of each example embodiment. That is, a computer-readable recording medium is included in the scope of each example embodiment. Furthermore, a recording medium that records the program and the program itself are also included in each example embodiment.

As the recording medium, for example, a floppy (registered trademark) disk, a hard disk, an optical disk, a magneto-optical disk, a Compact Disc (CD)-ROM, a magnetic tape, a nonvolatile memory card, and a ROM can be used. Not only a single program recorded in the recording medium that executes processing but also a program that operates on an Operating System (OS) and executes processing in cooperation with another software and a function of an expansion board are also included in the scope of each example embodiment.

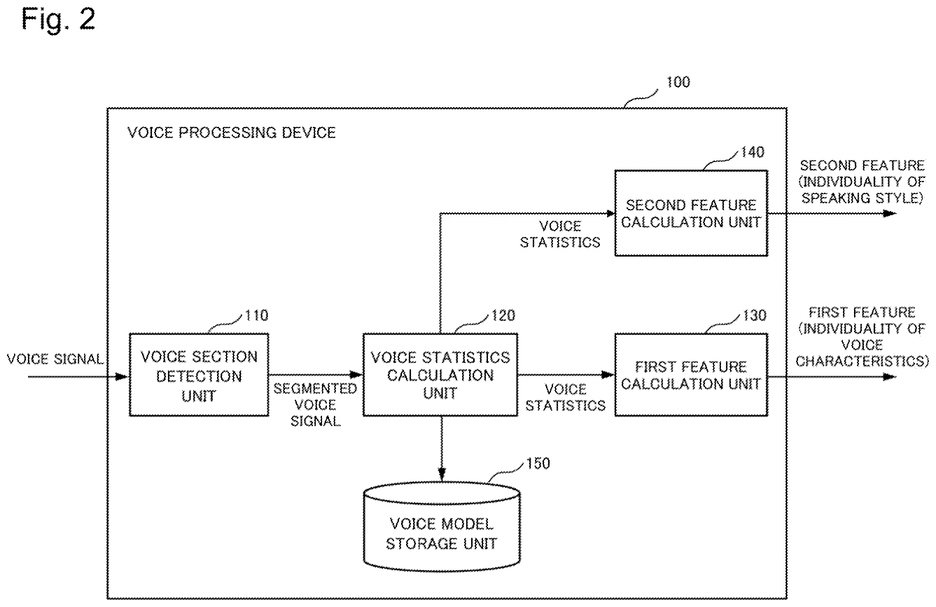

FIG. 2 is a block diagram illustrating a functional configuration of a voice processing device 100 according to the first example embodiment. As illustrated in FIG. 2, the voice processing device 100 includes a voice section detection unit 110, a voice statistics calculation unit 120, a first feature calculation unit 130, a second feature calculation unit 140, and a voice model storage unit 150.

The voice section detection unit 110 receives a voice signal from outside. The voice signal is a signal representing a voice based on an utterance of a speaker. The voice section detection unit 110 detects and segments a voice section included in the received voice signal. At this time, the voice section detection unit 110 may segment the voice signal into sections having a certain length or into sections having different lengths. For example, the voice section detection unit 110 may determine a section in the voice signal in which a volume is smaller than a predetermined value continuously for a certain period of time as a section having no sound and may determine and segment sections before and after the section having no sound as different voice sections. Then, the voice section detection unit 110 outputs a segmented voice signal that is a segmented result (processing result of voice section detection unit 110) to the voice statistics calculation unit 120. Here, reception of the voice signal means, for example, reception of a voice signal from an external device or another processing device or transfer of a processing result of voice signal processing from another program. An output means, for example, transmission to an external device or another processing device or transfer of the processing result of the voice section detection unit 110 to another program.

The voice statistics calculation unit 120 receives the segmented voice signal from the voice section detection unit 110. The voice statistics calculation unit 120 calculates acoustic characteristics on the basis of the received segmented voice signal and calculates voice statistics regarding a type of sound included in the segmented voice signal using the calculated acoustic characteristics and one or more voice models (to be described later in detail). Here, the type of the sound is, for example, a group defined based on linguistic knowledge such as phonemes. The type of the sound may be a group of sound obtained by clustering the voice signal on the basis of a similarity. Then, the voice statistics calculation unit 120 outputs the calculated voice statistics (processing result of voice statistics calculation unit 120). Hereinafter, voice statistics calculated for a certain voice signal is referred to as voice statistics of the voice signal. The voice statistics calculation unit 120 serves as voice statistics calculation means for calculating voice statistics that indicates an appearance of each type of sound included in a voice signal that indicates a voice.

An example of a method for calculating the voice statistics by the voice statistics calculation unit 120 is described. The voice statistics calculation unit 120 first calculates acoustic characteristics by executing frequency analysis processing on the received voice signal. A procedure for calculating the acoustic characteristics by the voice statistics calculation unit 120 is described.

The voice statistics calculation unit 120 converts, for example, the segmented voice signal received from the voice section detection unit 110 into a short-time frame time series by segmenting the segmented voice signal as a frame each short time and arranging the frames. Then, the voice statistics calculation unit 120 analyzes a frequency of each frame in the short-time frame time series and calculates the acoustic characteristics as a processing result. The voice statistics calculation unit 120 generates, for example, a frame of 25 milliseconds section for each 10 milliseconds as the short-time frame time series.

The voice statistics calculation unit 120 executes, for example, Fast Fourier Transform (FFT) and filter bank processing as the frequency analysis processing in such a way as to calculate frequency filter bank characteristics that are the acoustic characteristics. Alternatively, the voice statistics calculation unit 120 calculates Mel-Frequency Cepstrum Coefficients (MFCC) that are acoustic characteristics, or the like by executing discrete cosine transformation in addition to the FFT and the filter bank processing.

Next, a procedure for calculating the voice statistics using the calculated acoustic characteristics and one or more voice models stored in the voice model storage unit 150 by the voice statistics calculation unit 120 is described.

The voice model storage unit 150 stores one or more voice models. The voice model is configured to identify a type of sound indicated by a voice signal. The voice model stores an association relationship between the acoustic characteristics and the type of the sound. The voice statistics calculation unit 120 calculates a time series of numerical value information that indicates the type of the sound using the time series of the acoustic characteristics and the voice model. The voice model is a model that is trained in advance according to a general optimization reference using a voice signal prepared for training (voice signal for training). The voice model storage unit 150 may store, for example, two or more voice models trained for each of the plurality voice signals for training such as for each gender (male or female) of a speaker, for each recording environment (indoor or outdoor), or the like. In the example in FIG. 2, the voice processing device 100 includes the voice model storage unit 150. However, the voice model storage unit 150 may be achieved by a storage device different from the voice processing device 100.

For example, when the voice model to be used is a Gaussian Mixture Model (GMM), plural element distributions of the GMM are respectively related to different types of the sound. Then, the voice statistics calculation unit 120 extracts a parameter (average, variance) of each of the plurality of element distributions and a mixing coefficient of each element distribution from the voice model (GMM) and calculates a posterior probability of each element distribution on the basis of the calculated acoustic characteristics and the extracted parameter (average, variance) of the element distribution and the extracted mixing coefficient of each element distribution. Here, the posterior probability of each element distribution is an appearance of each type of sound included in a voice signal. A posterior probability Pᵢ (x) of an i-th element distribution of the Gaussian mixture model for a voice signal x can be calculated by the following formula (1).

$${P}_{i} ( x ) = \frac{{w}_{i} N ( x \vert {θ}_{i} )}{{\sum }_{j} {w}_{j} N ( x \vert {θ}_{j} )} \qquad ( 1 )$$

Here, a function N ( ) represents a probability density function of the Gaussian distribution, the reference θᵢ represents a parameter (mean and variance) of the i-th element distribution of the GMM, and the reference wᵢ represents a mixing coefficient of the i-th element distribution of the GMM.

For example, when the voice model to be used is a neural network, elements of an output layer included in the neural network are respectively related to different sound types. Therefore, the voice statistics calculation unit 120 extracts a parameter (weighting coefficient, bias coefficient) of each element from the voice model (neural network) and calculates an appearance of each type of sound included in the voice signal on the basis of the calculated acoustic characteristics and the extracted parameter (weighting coefficient, bias coefficient) of the element.

The appearance of each type of sound included in the voice signal calculated as described above is voice statistics. The first feature calculation unit 130 receives the voice statistics output from the voice statistics calculation unit 120. The first feature calculation unit 130 calculates a first feature using the voice statistics. The first feature is information to recognize specific attribute information from a voice signal. The first feature calculation unit 130 serves as first feature calculation means for calculating the first feature to recognize the specific attribute information, indicating speaker characteristics, on the basis of the voice statistics.

An example of a procedure for calculating the first feature by the first feature calculation unit 130 is described. Here, an example is described in which the first feature calculation unit 130 calculates a feature vector F (x) based on i-vector as the first feature of the voice signal x. The first feature F (x) calculated by the first feature calculation unit 130 may be a vector that can be calculated by performing predetermined calculation on the voice signal x, and it is sufficient that the first feature F (x) be characteristics of the speaker, and i-vector is an example thereof.

The first feature calculation unit 130 receives, for example, a posterior probability (hereinafter, also referred to as “acoustic posterior probability”) Pₜ (x) calculated for each short-time frame and acoustic characteristics Aₜ (x) (t is natural number equal to or more than one and equal to or less than L, L is natural number equal to or more than one) from the voice statistics calculation unit 120 as the voice statistics of the voice signal x. Pₜ (x) is a vector of which the number of elements is C. The first feature calculation unit 130 calculates a zero-order statistics S₀ (x) of the voice signal x on the basis of the following formula (2) using the acoustic posterior probability Pₜ (x) and the acoustic characteristics Aₜ (x). The, the first feature calculation unit 130 calculates a first-order statistics S₁ (x) on the basis of the formula (3).

$$\begin{matrix}{S}_{0} ( x ) = ( \begin{matrix}{S}_{0 , 1} {I}_{D} & … & 0 \\ ⋮ & ⋱ & ⋮ \\ 0 & … & {S}_{0 , C} {I}_{D}\end{matrix} ) , {S}_{0 , c} = {\sum }_{t = 1}^{L} {P}_{t , c} ( x ) & ( 2 ) \\ {S}_{1} ( x ) = {( {S}_{1 , 1}^{T} , {S}_{1 , 2}^{T} , … , {S}_{1 , C}^{T} )}^{T} , {S}_{1 , c} = {\sum }_{t = 1}^{L} {P}_{t , c} ( x ) ( {A}_{t} ( x ) - {m}_{c} ) & ( 3 )\end{matrix}$$

Subsequently, the first feature calculation unit 130 calculates F (x) that is the i-vector of the voice signal x on the basis of the following formula (4).

F(x)=(1+T^{T}Σ⁻¹S₀(x)T)⁻¹T^{T}Σ⁻¹S₁(x) (4)

In the above formulas (2) to (4), the reference P_{t, c} (x) indicates a value of a c-th element of Pₜ (x), the reference L indicates the number of frames obtained from the voice signal x, the reference S_{0, c} indicates a value of a c-th element of the statistics S₀ (x), the reference C indicates the number of elements of the statistics S₀ (x) and the number of elements of statistics S₁ (x), the reference D indicates the number of elements (the number of dimensions) of the acoustic characteristics Aₜ (x), the reference m_{c} indicates a mean vector of acoustic characteristics of a c-th region in an acoustic characteristics space, the reference I_{D} indicates an identity matrix (the number of elements is D×D), and the reference 0 indicates a zero matrix (the number of elements is D×D). The superscript T represents a transpose, and the character T which is not a superscript is a parameter for i-vector calculation. The reference Σ indicates a covariance matrix of the acoustic characteristics in the acoustic characteristics space.

As described above, the first feature calculation unit 130 calculates the feature vector F (x) based on the i-vector as the first feature F (x).

Next, a procedure for calculating a second feature to recognize specific attribute information from a voice signal by the second feature calculation unit 140 is described. The second feature calculation unit 140 serves as second feature calculation means for calculating the second feature to recognize the specific attribute information on the basis of a temporal change of the voice statistics.

First, an example of a method for calculating F2 (x) as the second feature of the voice signal x by the second feature calculation unit 140 is described. The second feature calculation unit 140 receives, for example, an acoustic posterior probability Pₜ (x) (t is natural number equal to or more than one and equal to or less than T, T is natural number equal to or more than one) calculated for each short-time frame as the voice statistics of the voice signal x from the voice statistics calculation unit 120. The second feature calculation unit 140 calculates an acoustic posterior probability difference ΔPₜ (x) using the acoustic posterior probability Pₜ (x). The second feature calculation unit 140 calculates the acoustic posterior probability difference ΔPₜ (x), for example, by the following formula (5).

ΔPₜ(x)=Pₜ(x)−Pₜ(x) (5)

That is, the second feature calculation unit 140 calculates a difference between acoustic posterior probabilities of which indexes are adjacent to each other (at least two time points) as the acoustic posterior probability difference ΔPₜ (x). Then, the second feature calculation unit 140 calculates a speaker characteristics vector calculated by replacing Aₜ (x) in the formulas (2) to (4) with ΔPₜ (x) as the second feature F2 (x). Here, the second feature calculation unit 140 may use some indexes, for example, even numbers or odd numbers, instead of using all the indexes t of the acoustic characteristics.

In this way, in the voice processing device 100, the second feature calculation unit 140 calculates the feature vector F2 (x) using the acoustic posterior probability difference ΔPₜ (x) as information (statistics) that indicates the temporal change of the appearance (voice statistics) of each type of sound included in the voice signal, for the voice signal x. The information that indicates the temporal change of the voice statistics indicates individuality of speaking style of a speaker. That is, the voice processing device 100 can output a feature that indicates the individuality of the speaking style of the speaker.

Next, another example of the method for calculating F2 (x) as the second feature of the voice signal x by the second feature calculation unit 140 is described. The second feature calculation unit 140 receives text information Lₙ (x) (n is natural number equal to or more than one and equal to or less than N, N is natural number equal to or more than one) that is a symbol string that represents pronunciation (utterance content) of the voice signal x. The text information is, for example, a phoneme string.

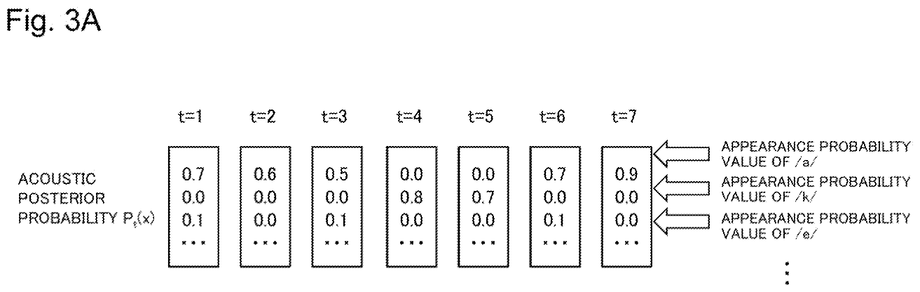

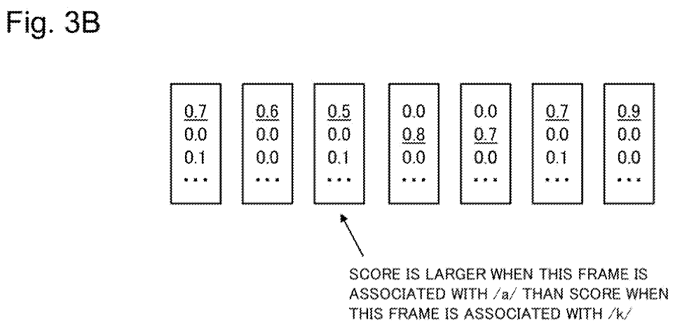

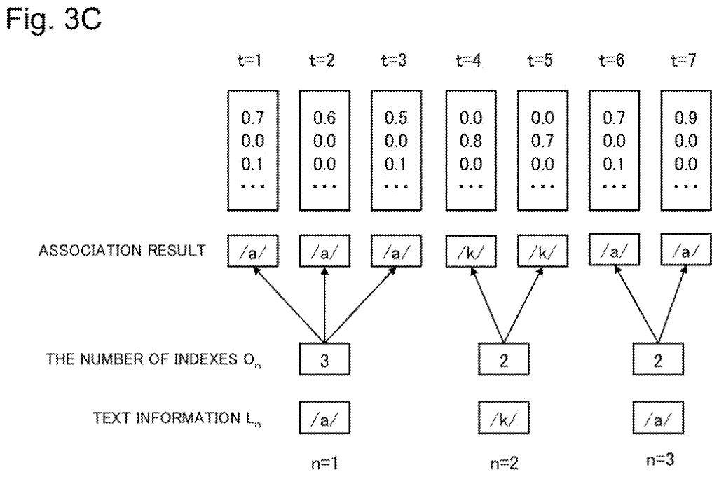

FIGS. 3A to 3C are diagrams for schematically explaining the method for calculating F2 (x) by the second feature calculation unit 140. As in the above example, the second feature calculation unit 140 receives the acoustic posterior probability Pₜ (x) as the voice statistics from the voice statistics calculation unit 120. For example, when the number of types of sound is “40”, Pₜ (x) is a 40-dimensional vector.

The second feature calculation unit 140 associates each element of the text information Lₙ (x) with each element of the acoustic posterior probability Pₜ (x). For example, it is assumed that the element of the text information Lₙ (x) be a phoneme, and the type of sound related to the element of the acoustic posterior probability Pₜ (x) be a phoneme. At this time, the second feature calculation unit 140 associates each element of the text information Lₙ (x) with each element of the acoustic posterior probability Pₜ (x) by using a matching algorithm based on dynamic programming, for example, using the appearance probability value of each phoneme in each index t of the acoustic posterior probability Pₜ (x) as a score.

A specific description will be made with reference to FIGS. 3A to 3C. An example is described in which the text information Lₙ (x) acquired by the second feature calculation unit 140 is a phoneme string of “red” (“aka” in Japanese), that is, for example, phonemes “/a/”, “/k/”, and “/a/”. FIG. 3A illustrates an acoustic posterior probability Pₜ (x) of each frame from a time t=1 to a time t=7. For example, a value “0.7” of a first element in an acoustic posterior probability P₁ (x) of the frame at the time t=1 represents an appearance probability value of the phoneme “/a/”. Similarly, a value “0.0” of a second element represents an appearance probability value of the phoneme “/k/”, and a value “0.1” of a third element represents an appearance probability value of the phoneme “/e/”. In this way, the second feature calculation unit 140 obtains appearance probability values of all phonemes for the frames from the time t=1 to the time t=7.

The second feature calculation unit 140 associates the acoustic posterior probability Pₜ(x) with the phoneme using the matching algorithm based on the dynamic programming using the appearance probability value as a score. For example, a “similarity” between the acoustic posterior probability P₁ (x) at the time t=1 and the text information “/a/” of an order n=1 is set to “0.7”. Similarly, similarities between all the elements of the acoustic posterior probability Pₜ (x) and all the elements of the text information are set. Then, on the basis of arrangement restriction of the text information “/a//k//a/”, each frame is associated with the phoneme in such a way as to maximize the similarity.

In FIG. 3B, the maximum score for each frame is underlined. For example, a score of an acoustic posterior probability P₃ (x) at t=3 is larger when being associated with “/a/” than that when being associated with “/k/”. In this way, a pattern that maximizes a total of scores of the phonemes is selected from among a large number of patterns, for example, “akaaaaa”, “aakaaaa”, “akkaaaa”, or the like. Here, it is assumed that “aaakkaa” is the pattern that maximizes the total score, that is, the result of the association.

The second feature calculation unit 140 calculates the number of indexes Oₙ of the acoustic posterior probability Pₜ (x) that can be associated with each element of the text information Lₙ (x).

As illustrated in FIG. 3C, the number of indexes Oₙ of an acoustic posterior probability Pₜ (x) that can be associated with a first “/a/” in text information “/a//k//a/” is “three”. Similarly, the number of indexes Oₙ of an acoustic posterior probability Pₜ (x) that can be associated with “/k/” is “two”, and the number of indexes Oₙ of an acoustic posterior probability Pₜ (x) that can be associated with the next “/a/” is “two”.

The second feature calculation unit 140 calculates a vector having the number of indexes Oₙ of the acoustic posterior probability Pₜ (x) that can be associated with each element of the text information Lₙ (x) as an element as a second feature F2(x). Each value of the numbers of indexes Oₙ represents an utterance time length of each phoneme (symbol) of the text information Lₙ (x).

In this way, the second feature calculation unit 140 of the voice processing device 100 calculates the feature vector F2(x), for the voice signal x, using the utterance time length of each element of the text information by further using text information that indicates a pronunciation of the voice signal x. With this calculation, the voice processing device 100 can output a feature that indicates the individuality of the speaking style of the speaker.

As described above, in the voice processing device 100 according to the present example embodiment, the first feature calculation unit 130 can calculate the feature vector that indicates the voice characteristics of the speaker. The second feature calculation unit 140 can calculate the feature vector that indicates the individuality of the speaking style of the speaker. As a result, the feature vector considering both the voice characteristics and the speaking style of the speaker can be output for the voice signal. That is, because the voice processing device 100 according to the present example embodiment can calculate the feature vector that indicates at least the individuality of the speaking style of the speaker, speaker characteristics suitable for enhancing accuracy of speaker recognition can be calculated.

Operation of First Example Embodiment

Next, an operation of the voice processing device 100 according to the first example embodiment is described with reference to the flowchart in FIG. 4. FIG. 4 is a flowchart illustrating an example of the operation of the voice processing device 100.

The voice processing device 100 receives one or more voice signals from outside and provides the signals to the voice section detection unit 110. The voice section detection unit 110 segments the received voice signal and outputs segmented voice signals to the voice statistics calculation unit 120 (step S101).

The voice statistics calculation unit 120 executes short-time frame analysis processing on each of the one or more received segmented voice signals and calculates time-series acoustic characteristics and time-series voice statistics (step S102).

The first feature calculation unit 130 calculates and outputs a first feature on the basis of the one or more time-series acoustic characteristics and time-series voice statistics that have been received. (step S103).

The second feature calculation unit 140 calculates and outputs a second feature on the basis of the one or more time-series acoustic characteristics and time-series voice statistics that have been received. (step S104). When the reception of the voice signals from outside is completed, the voice processing device 100 terminates the series of processing.

Effects of First Example Embodiment

As described above, according to the voice processing device 100 according to the present example embodiment, it is possible to enhance the speaker recognition using the speaker characteristics calculated by the voice processing device 100. This is because the voice processing device 100 calculates the first feature that indicates the voice characteristics of the speaker by the first feature calculation unit 130 and calculates the second feature that indicates the speaking style of the speaker by the second feature calculation unit 140 in such a way as to output the feature vector considering both of the voice characteristics and the speaking style of the speaker as the feature.

In this way, according to the voice processing device 100 according to the present example embodiment, the feature vector considering the voice characteristics and the speaking style of the speaker is calculated for the voice signal. As a result, even in a case where voice qualities of speakers are similar to each other, a feature suitable for the speaker recognition can be obtained on the basis of a difference in the speeches, for example, a difference in a speed of speaking a word, a timing of switching sounds in a word, or the like.

### Second Example Embodiment

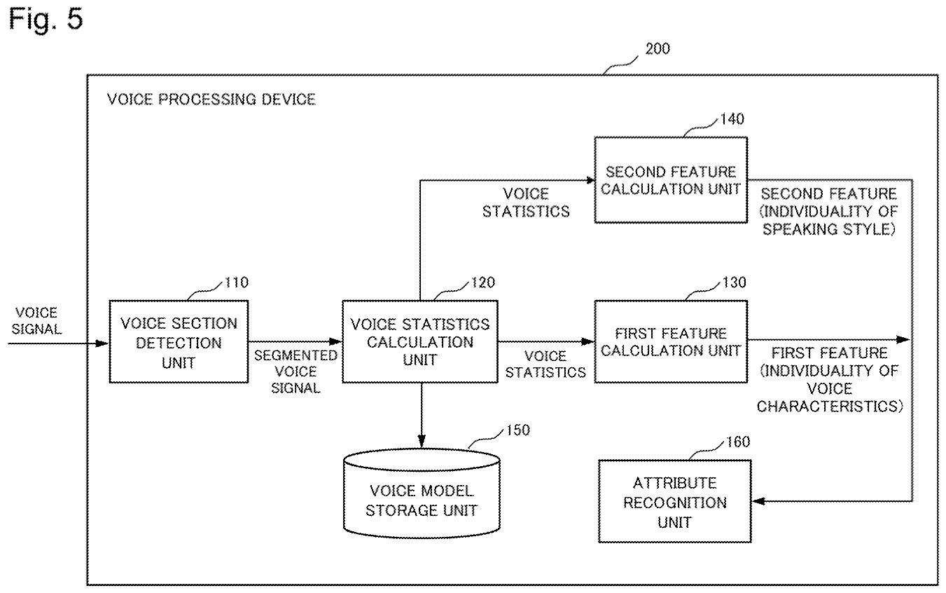

FIG. 5 is a block diagram illustrating a configuration of a voice processing device 200 according to a second example embodiment. As illustrated in FIG. 5, the voice processing device 200 further includes an attribute recognition unit 160 in addition to the components of the voice processing device 100 described in the first example embodiment. The attribute recognition unit 160 may be provided in another device that can communicate with the voice processing device 100. The attribute recognition unit 160 serves as attribute recognition means for recognizing specific attribute information included in a voice signal on the basis of a second feature.

By using the second feature calculated by the second feature calculation unit 140 described in the first example embodiment, the attribute recognition unit 160 can perform speaker recognition for estimating a speaker of a voice signal.

For example, the attribute recognition unit 160 calculates a cosine similarity as an index that represents a similarity between two second features from a second feature calculated from a first voice signal and a second feature calculated from a second voice signal. For example, for speaker verification, verification determination information based on the similarity may be output.

Furthermore, for speaker identification, the plurality of second voice signals is prepared for the first voice signal, for example, a similarity between the second feature calculated from the first voice signal and each second feature calculated from each of the plurality of second voice signals is obtained, and a pair having the largest similarity may be output.

As described above, according to the second example embodiment, the voice processing device 200 obtains an effect that the attribute recognition unit 160 can perform the speaker recognition for estimating the speaker on the basis of the similarity between the features respectively calculated from the plural voice signals.

The attribute recognition unit 160 may perform the speaker recognition for estimating the speaker of the voice signal using the second feature calculated by the second feature calculation unit 140 and the first feature calculated by the first feature calculation unit 130. As a result, the attribute recognition unit 160 can enhance accuracy of the speaker recognition.

### Third Example Embodiment

A minimum configuration of an example embodiment of the present disclosure is described.

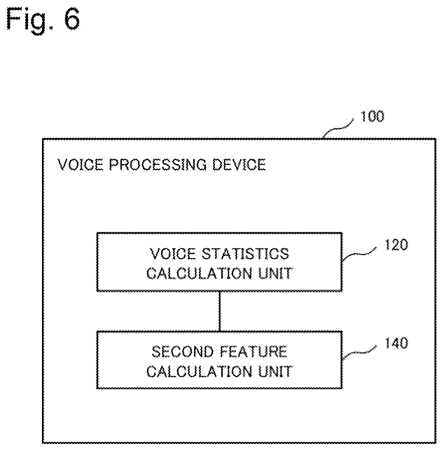

FIG. 6 is a block diagram illustrating a functional configuration of a voice processing device 100 according to an example embodiment having a minimum configuration of the present disclosure. As illustrated in FIG. 6, the voice processing device 100 includes voice statistics calculation unit 120 and a second feature calculation unit 140.

The voice statistics calculation unit 120 calculates voice statistics that indicates an appearance of each type of sound included in a voice signal that indicates a voice. The second feature calculation unit 140 calculates a second feature to recognize specific attribute information on the basis of a temporal change of the voice statistics.

By adopting the above configuration, according to the third example embodiment, a feature vector that indicates individuality of speaking style of a speaker can be calculated. Therefore, an effect is obtained that accuracy of speaker recognition can be enhanced.

The voice processing device 100 is an example of a feature calculation device that calculates a feature to recognize specific attribute information from a voice signal. When a specific attribute indicates a speaker who utters a voice signal, the voice processing device 100 can be used as a speaker characteristics extraction device. The voice processing device 100 can be used, for example, as a part of a voice recognition device that includes a mechanism for adapting to characteristics of speaking style of a speaker on the basis of speaker information estimated by using the speaker characteristics with respect to a voice signal of a sentence utterance. Here, information indicating the speaker may be information indicating a gender of the speaker or may be information indicating an age or an age group of the speaker.

The voice processing device 100 can be used as a language characteristics calculation device when the specific attribute is assumed as information indicating a language (language configuring voice signal) transferred by the voice signal. The voice processing device 100 can be used, for example, as a part of a voice translation device that includes a mechanism for selecting a language to be translated on the basis of language information estimated by using the language characteristics with respect to a voice signal of a sentence utterance.

The voice processing device 100 can be used as an emotion characteristics calculation device when the specific attribute is assumed as information indicating an emotion of the speaker at the time of speech. The voice processing device 100 can be used, for example, as a part of a voice search device or a voice display device that includes a mechanism for specifying a voice signal related to a specific emotion on the basis of the emotion information estimated by using the emotion characteristics with respect to voice signals of a large number of accumulated utterances. The emotion information includes, for example, information indicating an emotional expression, information indicating personality of a speaker, or the like.

As described above, the specific attribute information according to the present example embodiment is information indicating at least one of the speaker who utters the voice signal, the language configuring the voice signal, the emotional expression included in the voice signal, and the personality of the speaker estimated from the voice signal.

While the present disclosure has been described above with reference to exemplary embodiments, the present disclosure is not limited to these embodiments. It will be understood by those of ordinary skill in the art that various changes in form and details may be made therein without departing from the spirit and scope of the present disclosure as defined by the claims. That is, it goes without saying that the present disclosure can be variously modified without being limited to the above example embodiments and these modifications are included in the scope of the present disclosure.

As described above, the voice processing device or the like according to one aspect of the present disclosure has an effect that the voice processing device can extract the feature vector considering how to pronounce words in addition to the voice characteristics of the speaker and enhance the accuracy of the speaker recognition and is useful as the voice processing device or the like and the speaker recognition device.

### REFERENCE SIGNS LIST

100 voice processing device
110 voice section detection unit
120 voice statistics calculation unit
130 first feature calculation unit
140 second feature calculation unit
150 voice model storage unit
160 attribute recognition unit

What is claimed is:

1. A voice processing device comprising one or more memories storing instructions and one or more processors configured to execute the instructions to:
calculate voice statistics that indicates an appearance of each type of sound included in a voice signal that indicates a voice; and
calculate a second feature to recognize specific attribute information based on a temporal change of the voice statistics.

2. The voice processing device according to claim 1, wherein the one or more processors are configured to execute the instructions to
calculate a first feature to recognize the specific attribute information that indicates speaker characteristics based on the voice statistics.

3. The voice processing device according to claim 1, wherein the one or more processors are configured to execute the instructions to
calculate the temporal change of the voice statistics using the voice statistics at least at two time points as the second feature.

4. The voice processing device according to claim 1, wherein the one or more processors are configured to execute the instructions to
associate text information that is a symbol string that indicates utterance content of the voice signal with the voice statistics and
calculate a value that indicates an utterance time length of each symbol indicating the utterance content as the second feature.

5. The voice processing device according to claim 1, wherein the one or more processors are configured to execute the instructions to
recognize the specific attribute information included in the voice signal based on the second feature.

6. The voice processing device according to claim 1, wherein
the specific attribute information is
information that indicates at least any one of a speaker who utters the voice signal, a gender of the speaker who utters the voice signal, an age of the speaker who utters the voice signal, a language configuring the voice signal, an emotional expression included in the voice signal, and personality of the speaker estimated from the voice signal.

7. A voice processing method comprising:
calculating voice statistics that indicates an appearance of each type of sound included in a voice signal that indicates a voice; and
calculating a second feature to recognize specific attribute information based on a temporal change of the voice statistics.

8. A non-transitory program recording medium that records a program for causing a computer to execute:
processing for calculating voice statistics that indicates an appearance of each type of sound included in a voice signal that indicates a voice; and
processing for calculating a second feature to recognize specific attribute information based on a temporal change of the voice statistics.
